(19) United States
(12) Patent Application Publication
(10) Pub. No.: US 2009/0230725 A1
(43) Pub. Date: Sep. 17, 2009

(54) Systems for reducing form drag on vehicles through a dimpled surface

(76) Inventor: Daniel Juieng, Atlanta, GA (US)

Correspondence Address: Daniel Juieng, 743-2 Houston Mill Road, Atlanta, GA, 30329, US

(21) Appl. No.: 12/381,641

(22) Filed: Mar. 13, 2009

Related U.S. Application Data
(60) Provisional application No. 61/069,522, filed on Mar. 14, 2008.

(51) Int. Cl. B62D 37/02; B62D 39/00

(52) U.S. Cl. 296/180.4; 296/1.01

(57) ABSTRACT

A drag reducing system is disclosed for reducing drag on a motor vehicle. For some embodiments, the drag reducing apparatus comprises one or more dimpled panels each comprising a sheet with dimples distributed on the surface of the sheet. For such embodiments, the one or more dimpled panels are coupled to one or more sides of the motor vehicle. Furthermore, the one or more dimpled panels are positioned in a contiguous manner on the one or more sides of the motor vehicle.

### CROSS-REFERENCE TO RELATED APPLICATION

This application claims priority to, and the benefit of, U.S. Provisional Patent Application entitled, “A Method of Reducing Form Drag on Vehicles and Trailers Through the use of a Dimpled Surface,” having Ser. No. 61/069,522, filed on Mar. 14, 2008, which is incorporated by reference in its entirety.

### TECHNICAL FIELD

The present disclosure generally relates to reducing drag on motor vehicles, and particularly, to reducing form drag on motor vehicles through the use of a dimpled surface.

### BACKGROUND

It is generally known that form drag arises based on the form of a given object. In particular, the general size and shape of the object affect the amount of drag that a moving object such as a motor vehicle experiences. Objects with a larger apparent cross-section will have a higher drag than thinner bodies. As such, a significant amount of aerodynamic drag is created when a large vehicle such as a tractor-trailer travels along a highway. The amount of form drag experienced by a moving vehicle directly impacts the fuel consumption of the vehicle, thereby increasing costs associated with operating the vehicle. When transporting goods across a long distance, for example, an increase in fuel efficiency can lead to a significant savings in fuel costs.

### SUMMARY

Briefly described, one embodiment, among others, includes a drag reducing system for reducing drag on a motor vehicle. For some embodiments, the drag reducing apparatus comprises one or more dimpled panels each comprising a sheet with dimples distributed on the surface of the sheet. For such embodiments, the one or more dimpled panels are coupled to one or more sides of the motor vehicle. Furthermore, the one or more dimpled panels are positioned in a contiguous manner on the one or more sides of the motor vehicle.

Another embodiment is a drag reducing assembly for reducing form drag of a moving motor vehicle. The drag reducing assembly comprises a flexible sheet with a thickness about 0.2 centimeter to about 10 centimeters. The assembly further comprises a plurality of round dimples distributed on the flexible sheet such that the flexible sheet comprises a dimpled surface. In accordance with such embodiments, the flexible sheet is detachably coupled to a motor vehicle, wherein the flexible sheet is coupled to the motor vehicle such that the side of the flexible sheet with cavities formed by the dimples on the flexible sheet is facing outward away from the surface of the motor vehicle.

Another embodiment is a motor vehicle body that comprises a plurality of dimpled sides each comprising bumps distributed on the surfaces of the dimpled sides, wherein the bumps each have a height of approximately 0.2 to 10 centimeters.

### BRIEF DESCRIPTION OF THE DRAWINGS

Various aspects of the disclosure can be better understood with reference to the following drawings. The components in the drawings are not necessarily to scale, with emphasis instead being placed upon clearly illustrating the principles of the present disclosure. Moreover, in the drawings, like reference numerals designate corresponding parts throughout the several views.

FIG. 1 depicts a motor vehicle on which the various embodiments described may be implemented.

FIGS. 2A-B illustrate the form drag experienced by the motor vehicle in FIG. 1 with and without a dimpled surface in accordance with some embodiments

FIG. 3 shows one of the dimpled panels attached to the motor vehicle shown in FIGS. 1-2.

FIG. 4 depicts various shapes in which the dimples shown in the dimpled panels of FIG. 3 may be formed.

FIGS. 5-7 depict perspective views and side views of various embodiments of the dimpled panels.

### DETAILED DESCRIPTION

Having summarized various aspects of the present disclosure, reference will now be made in detail to the description of the disclosure as illustrated in the drawings. As described in the background, a significant amount of aerodynamic drag is created when a large vehicle such as a tractor-trailer travels along a highway. The amount of form drag experienced by a moving vehicle directly impacts the fuel consumption of the vehicle, thereby increasing costs associated with operating the vehicle. As such, when transporting goods cross-country in a tractor-trailer, an increase in fuel efficiency can lead to a significant savings in fuel costs. Various embodiments thus are described for implementing one or more dimpled surfaces for reducing the form drag on a motor vehicle when the motor vehicle is moving. In particular, a plurality of dimples is distributed on one or more sheets which are attached to the surface of a trailer attached to a motor vehicle.

In alternative embodiments, bumps or protuberances, rather than dimples, may be used to achieve similar results. Furthermore, the dimples or bumps may be incorporated directly onto the surface of the trailer. While application of the various embodiments described is not limited to a particular range of speeds, a substantial reduction in form drag may be observed when the motor vehicle is moving approximately 45 mpg to 75 mph. One of ordinary skill in the art will appreciate that a reduction in form drag exerted on a vehicle or trailer results in less energy being required to move the vehicle or trailer, thereby improving the fuel efficiency for the vehicle. As will be described later in this disclosure, the various embodiments may be implemented in an inexpensive manner and may be readily attached and fitted to any vehicle.

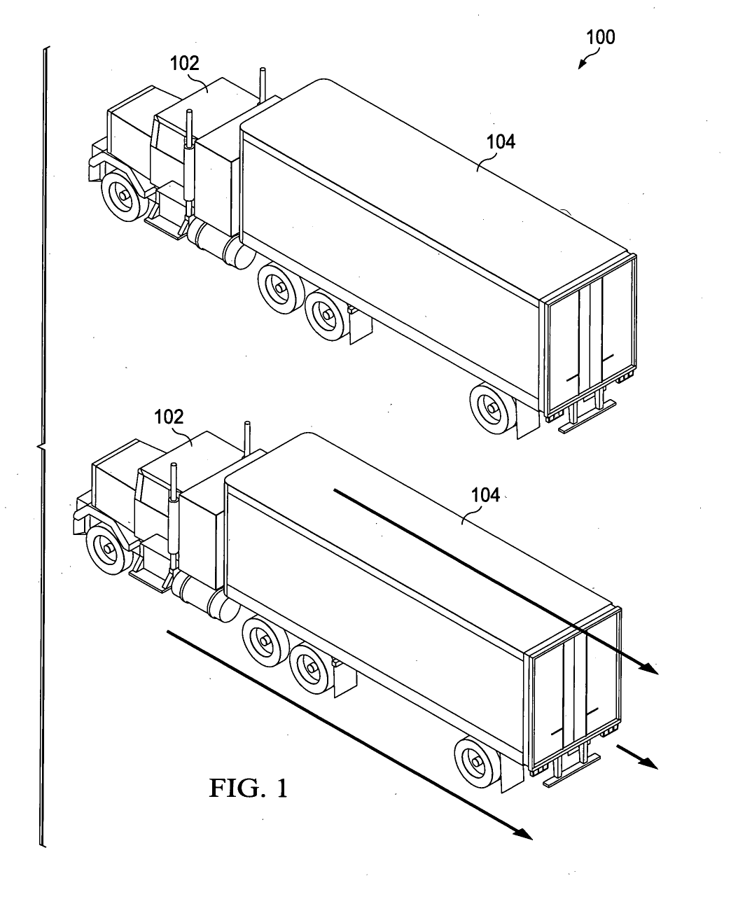

Reference is made to FIG. 1, which depicts a motor vehicle 100 on which the various embodiments described may be implemented. The motor vehicle 100 may comprise, for example, a truck used for commercial transportation of goods and may comprise a tractor unit 102 and a trailer 104 used for storing and transporting goods. It is commonly known that some trailers 104 are utilized for personal use with practically any powered vehicle such as a pick-up truck having an appropriate hitch, while larger trailers 104 are part of large trucks called semi-trailer trucks for transportation of cargo.

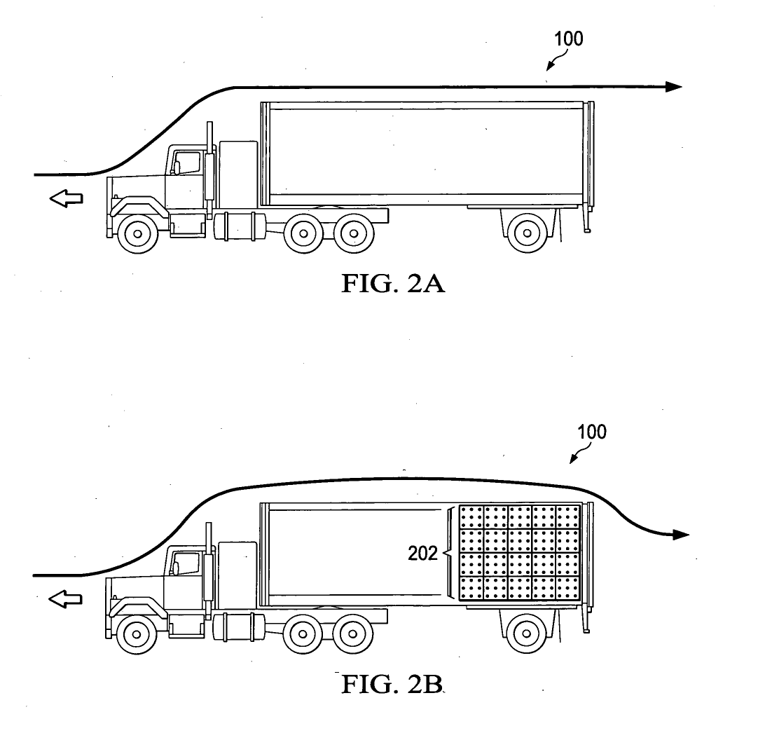

Reference is now made to FIGS. 2A-B, which illustrate the form drag experienced by a motor vehicle 100 with and without a dimpled surface. As known by those of ordinary skill in the art, drag or “form drag” is generated based on the form of the object. The general size and shape of a particular body (e.g., a trailer 104) is the primary factor in form drag. Bodies with a larger apparent cross-section will have a higher drag than thinner bodies. Aerodynamic designs or designs that are streamlined with a varying cross-sectional area also affect form drag. Form drag follows the drag equation in that it rises with the square of speed, and thus becomes more important a high speeds. Shown in FIG. 2A is a motor vehicle 100 such as the one depicted in FIG. 1 with no modifications. The form drag experienced by the motor vehicle 100 is also shown. FIG. 2B depicts a motor vehicle 100 with a dimpled surface. As will be described later, panels 202 with dimpled surfaces may be attached to the surface of the motor vehicle 100 to reduce form drag.

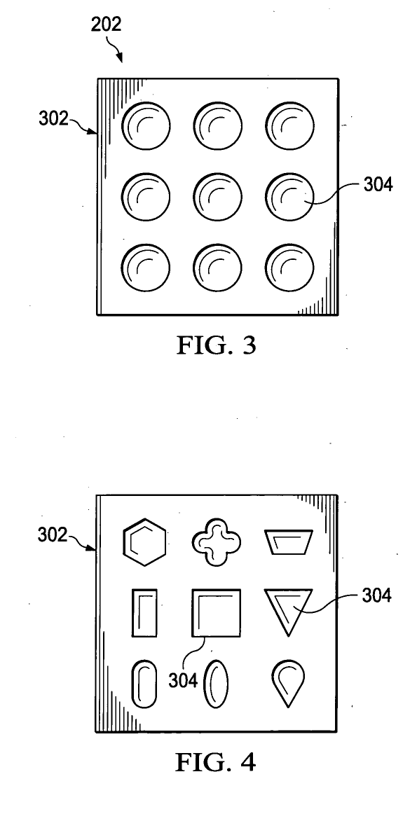

FIG. 3 shows one of the dimpled panels 202 attached to the motor vehicle 100 in FIG. 2. In accordance with some embodiments, dimples 304 are embedded into flexible sheets 302 which are readily attached to the surface of a vehicle 100. The sheets 302 may be constructed from a variety of materials, including, but not limited to, rubber and plastic. Further, the dimpled sheets 202 may be attached to the surface of a vehicle in variety ways, such as with an adhesive or with mechanical fasteners. For other embodiments, the dimpled sheets 202 may be magnetic. The sheets 302 may be constructed in a variety of shapes, including but not limited to, a polygonal shape such as a square, rectangle, triangle, hexagon, etc. In other embodiments, the sheets 302 may comprise a non-polygonal shape such as, but not limited to, a circle, an oval, a decorative shape, an amorphous shape, among other shapes.

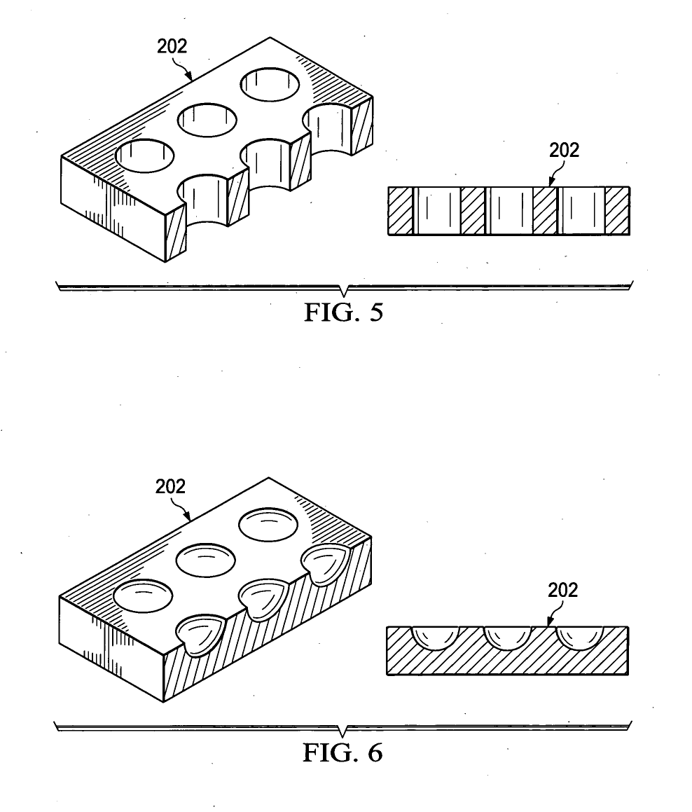

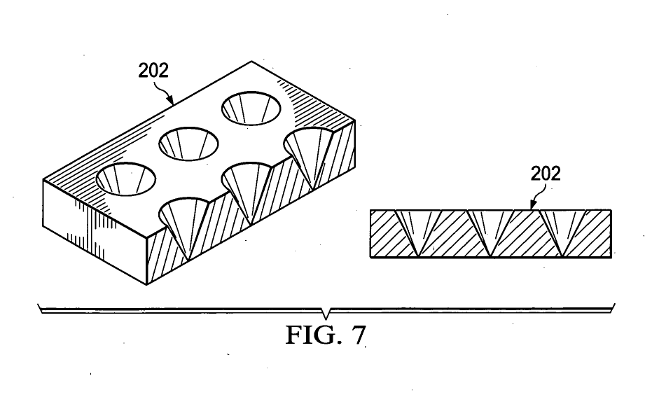

The dimples 304 depicted in FIG. 3 may be concave with respect to the sheets 302 such that an indentation is formed in the sheets. Alternatively, the dimples 304 may be cut perpendicularly to the surface of the sheet 302 such that through holes are formed in the sheet 302. By way of illustration, the holes on a peg board are cut in a similar manner. The dimples 304 may be cut entirely through the sheets, or they 304 may be cut partially through the sheets 302. Regarding the distribution of the dimples 304 on the sheet 302, the dimples 304 may be spaced randomly, increasingly apart, decreasingly apart, etc. Furthermore, the dimples 304 may be spaced based on a variety of distances. For example, the dimples 304 may be spaced starting from a fraction of a centimeter apart and gradually to a few centimeters apart. With reference to FIG. 4, the dimples may be implemented in any number of shapes. Referring back to the motor vehicle in FIG. 2B, the dimpled sheets 202 are preferably installed next to each other on the surface of the motor vehicle 100. To minimize the weight by the dimpled sheets 202, the dimpled sheets 202 are preferably constructed to be less than a few centimeters thick. FIGS. 5-7 depict perspective views and side views of various embodiments of the dimpled panels.

Having described the basic structure of the dimpled sheets 202, the effect on form drag of a motor vehicle is now described in more detail. Incorporating a dimpled surface on a moving vehicle increases the fuel efficiency of a vehicle as the dimples reduce the form drag of a vehicle or a vehicle's trailer. As one of ordinary skill will appreciate, a dimpled surface changes the airflow from a laminar flow to a turbulent flow, and turbulent flow has more energy than laminar flow. As such, the flow stays attached (i.e., the air experiences adhesion) longer on the surface with turbulent flow than on the surface with laminar flow.

Referring back briefly to FIGS. 2A-B, FIG. 2A shows the laminar flow over a heavy-duty tractor-trailer 100 that does not have a dimpled surface. FIG. 2B shows the turbulent flow over a heavy-duty tractor-trailer 100 with a dimpled surface 202. As shown, the turbulent flow delays the separation of the flow behind the vehicle or behind the trailer 100. The result of this delay in separation of the air flow is a decrease in the form drag, also called pressure drag, exerted on the vehicle 100 or the trailer 104. With less drag on the vehicle 100 or trailer 104, less energy is needed to move the vehicle or trailer forward. This ultimately leads to increased fuel efficiency of the engine that moves the vehicle 100 or trailer 104.

It should be noted that for other embodiments, bumps or protuberances, rather than dimples, may be used to achieve similar results. In particular, the sheets 302 may contain bumps on them instead of dimples. Alternatively, bumps may be attached directly onto the side of a vehicle 100 or trailer 104. It should further be noted that the various embodiments described may be implemented on watercraft, aircraft, and other objects (recreational objects, unmanned objects, etc.). For embodiments where a dimpled surface is implemented directly onto the surface of a motor vehicle 100, the dimpled surface can be implemented at the time of manufacture of the vehicle or trailer. For instance, when the trailer of a heavy-duty tractor-trailer is being manufactured, a group of dimples can be applied to the surface of the trailer. Alternatively, when the trailer of a heavy-duty tractor-trailer is being manufactured, a group of dimples can be applied to the surface of an object or objects, such as sheets of plastic, and these objects can then be applied to the surface of the trailer.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

At least the following is claimed:

1. A drag reducing system for reducing drag on a motor vehicle, the drag reducing apparatus comprising:
one or more dimpled panels each comprising a sheet with dimples distributed on the surface of the sheet, wherein the one or more dimpled panels are coupled to one or more sides of the motor vehicle, the one or more dimpled panels being positioned in a contiguous manner on the one or more sides of the motor vehicle.

2. The system of claim 1 further comprising one or more fasteners for attaching the one or more dimpled panels to the one or more sides of the motor vehicle.

3. The system of claim 1, wherein the dimples comprise round indentations on the surface of the one or more dimpled panels.

4. The system of claim 3, wherein the dimples have a depth of approximately 0.2 to 10 centimeters.

5. The system of claim 1, wherein the dimples comprise through holes in the one or more dimpled panels.

6. The system of claim 1, wherein each of the one or more dimpled panels have a thickness of about 0.2 to 10 centimeters.

7. A drag reducing assembly for reducing form drag of a moving motor vehicle, comprising:
a flexible sheet with a thickness about 0.2 centimeter to about 10 centimeters;
a plurality of round dimples distributed on the flexible sheet such that the flexible sheet comprises a dimpled surface, the flexible sheet detachably coupled to a motor vehicle.

8. The assembly of claim 4, wherein the flexible sheet is detachably coupled to the motor vehicle by a plurality of fasteners.

9. The assembly of claim 4, wherein the flexible sheet is magnetically coupled to the motor vehicle.

10. A motor vehicle body, comprising:
a plurality of dimpled sides each comprising dimples distributed on the surfaces of the motor vehicle body, wherein the dimples each have a depth of approximately 0.2 to 10 centimeters.
